(19) United States
(12) Patent Application Publication
(10) Pub. No.: US 2025/0279253 A1
(43) Pub. Date: Sep. 4, 2025

(54) DISTRIBUTION LINE VOLTAGE HARVESTER

(71) Applicant: Hubbell Incorporated, Shelton, CT (US)

(72) Inventors: David Adelbert Rhein, Birmingham, AL (US); Chandiran Sundarraj, Tamilnadu (IN); Mariappan Veilumuthu, Tamilnadu (IN); Dragan Tabakovic, Shelton, CT (US)

(21) Appl. No.: 19/064,939

(22) Filed: Feb. 27, 2025

Related U.S. Application Data
(60) Provisional application No. 63/638,190, filed on Apr. 24, 2024.
(60) Provisional application No. 63/560,216, filed on Mar. 1, 2024.

(51) Int. Cl. H01H 33/28; H01H 33/66; H01H 33/662; H02J 50/00; H02J 50/05

(52) U.S. Cl. CPC H01H 33/28; H01H 33/6606; H01H 33/66207; H02J 50/001; H02J 50/05

(57) ABSTRACT

A distribution protection device includes an energy harvester connected in series between a first terminal and a second terminal, a switch connected in series between the first terminal and the second terminal and in parallel with the energy harvester, and switch circuitry configured to receive electrical power from the energy harvester and control operation of the switch. The energy harvester includes a first capacitive layer opposite a second capacitive layer. The first capacitive layer and the second capacitive layer form a substantially cylindrical structure that substantially envelopes the switch.

### CROSS-REFERENCE TO RELATED APPLICATIONS

This application claims the benefit of U.S. Provisional Application No. 63/638,190, filed Apr. 24, 2024, and U.S. Provisional Application No. 63/560,216 filed Mar. 1, 2024, the entire disclosure of both of which are incorporated by reference.

### FIELD

The present disclosure relates to current interrupters and, more particularly, to self-powered current interrupters including energy harvesters for harvesting power from a power line.

### SUMMARY

Distribution protection devices such as reclosers and fuses maintain the reliability and efficiency of electrical distribution systems by detecting and isolating faults. For example, distribution protection devices may detect faults such as abnormally high currents (which could indicate short circuits or overloads) and/or under-voltage, over-voltage, and/or voltage imbalance conditions (which could indicate voltage irregularities) in the electrical distribution systems. In response to detecting a fault, the distribution protection devices can interrupt current flow to the affected sections of the electrical distribution system. For example, a distribution protection device may be connected to a power line and interrupt current flow through the power line. To improve the reliability, continuity of service, and operational efficiency of the electrical distribution system, the distribution protection device may be able to automatically restore power to the affected section. For example, the distribution protection device may automatically restore power to the affected section after the fault is no longer present and/or a period of time passes.

Distribution protection devices may require electrical power to automatically restore power. For example, reclosers may include mechanical contacts that move between open and closed positions. Electrical power may be required to drive motors, hydraulic systems, and/or other mechanisms to move the contacts between the open and closed positions to connect or disconnect the power line. Distribution protection devices may also include control systems that monitor conditions of the electrical distribution system (for example, by monitoring conditions at the power line) and/or implement control logic to determine when to disconnect and when to restore power. Such control systems may also require electrical power for operation. Thus, distribution protection devices may need reliable access to electrical power for operation even when the power line is disconnected.

Some examples of distribution protection devices include energy harvesters (such as voltage or current harvesters) that harvest energy from the power line to provide electrical power for operation of the distribution protection device. However, such energy harvesters may be provided in series with the distribution protection device to ensure that the power line is disconnected when the distribution protection device is in an open position. Thus, such energy harvesters may not be able to provide electrical power to the distribution protection device when it is in the open position. To power the distribution protection device when it is in the open position, various examples of distribution protection devices include energy storage mechanisms such as supercapacitors and/or batteries. However, supercapacitors and batteries may degrade over time, potentially reducing the reliability of the distribution protection devices in some scenarios. Thus, what is needed are distribution protection devices that can harvest power from power lines when they are in the open position, eliminating the need for supercapacitors and/or batteries.

Systems, methods, apparatus, and techniques described in this specification address these and other technical problems by providing an energy harvester around the power line in parallel with the switch (such as the contacts) of the distribution protection device. In various implementations, the energy harvester may be part of or form a high-impedance circuit. Thus, even when the switch is in the open position, the high-impedance of the high-impedance circuit ensures that it does not provide an alternative path for significant current flows when the switch of the distribution protection device is open. Since only a low amount of current is able to flow through the high-impedance circuit, opening the switch effectively disconnects the power line. However, the energy harvester is able to harvest sufficient electrical energy through the high-impedance circuit to power the mechanisms and/or control systems of the distribution protection device even when the switch is open. Thus, the energy harvester is able to provide power for the distribution protection device when the switch is open without requiring supercapacitors and/or batteries.

A distribution protection device includes an energy harvester connected in series between a first terminal and a second terminal, a switch connected in series between the first terminal and the second terminal and in parallel with the energy harvester, and switch circuitry configured to receive electrical power from the energy harvester and control operation of the switch. The energy harvester includes a first capacitive layer opposite a second capacitive layer. The first capacitive layer and the second capacitive layer form a substantially cylindrical structure that substantially envelopes the switch.

In other features, the energy harvester includes a dielectric layer positioned between the first capacitive layer and the second capacitive layer. In other features, the energy harvester is part of a high-impedance circuit between the first terminal and the second terminal and the high-impedance circuit includes energy harvester circuitry configured to receive alternating current from the energy harvester and provide direct current to the switch circuitry. In other features, the energy harvester circuitry is configured to increase an impedance of the high-impedance circuit. In other features, the energy harvester includes a dielectric layer covering the first capacitive layer and the second capacitive layer. In other features, the energy harvester, the switch, and the switch circuitry are positioned within a housing. In other features, the switch is a vacuum interrupter.

A distribution protection device includes a power line extending between a first terminal and a second terminal, a switch connected in series between the first terminal and the second terminal, a capacitive core extending around the power line and connected in parallel with the switch. The switch is configured to substantially interrupt a flow of electrical power between the first terminal and the second terminal in an open position. The capacitive core is configured to continue harvesting electrical power from the power line when the switch is in the open position.

In other features, the capacitive core includes one or more dielectric layers sandwiched between one or more capacitive layers. In other features, the capacitive core includes a plurality of dielectric layers sandwiched between a plurality of capacitive layers. In other features, the plurality of capacitive layers forms a voltage divider. In other features, the capacitive core includes a first plurality of capacitive sections disposed on a first side of a dielectric layer and a second plurality of capacitive sections disposed on a second side of the dielectric layer. In other features, the first plurality of capacitive sections overlaps with the second plurality of capacitive sections. In other features, the capacitive core is part of a first circuit and the switch is part of a second circuit. The first circuit has a higher impedance than the second circuit. In other features, the capacitive core and the switch are disposed within a housing. In other features, the housing is a vacuum bottle. In other features, the first terminal and the second terminal are configured to be connected to an electrical distribution system power line.

A capacitive core for a distribution protection device includes one or more dielectric layers sandwiched between one or more capacitive layers. The one or more dielectric layers and the one or more capacitive layers are configured to envelop a switch configured to substantially interrupt a flow of electrical energy through a power line. The one or more dielectric layers and the one or more capacitive layers are configured to harvest electrical power from the power line. The capacitive core is configured to form part of a first circuit extending between a first terminal and a second terminal of the distribution protection device. The distribution protection device includes a second circuit configured to interrupt a flow of electrical power between the first terminal and the second terminal. The first circuit is in parallel with the second circuit. The first circuit has a higher impedance than the second circuit. The one or more dielectric layers and the one or more capacitive layers are configured to continue harvesting electrical power from the power line when the second circuit interrupts the flow of electrical power between the first terminal and the second terminal.

In other features, the one or more dielectric layers and the one or more capacitive layers are configured to provide the harvested electrical power to the second circuit when the second circuit interrupts the flow of electrical power between the first terminal and the second terminal. In other features, the first circuit is configured to receive alternating current from the one or more dielectric layers and the one or more capacitive layers and provide direct current to the second circuit.

Other examples, embodiments, features, and aspects will become apparent by consideration of the detailed description and accompanying drawings.

### BRIEF DESCRIPTION OF THE DRAWINGS

FIG. 1 is an isometric view of an example distribution protection device according to some embodiments.

FIG. 2 is a front view of the distribution cutout of FIG. 1, according to some embodiments.

FIG. 3 is a front view of the circuit interrupter of FIG. 1, according to some embodiments.

FIG. 4 is an exploded view of the circuit interrupter of FIGS. 1 and 3, according to some embodiments.

FIG. 5 is a front view of the internal assembly of the circuit interrupter of FIGS. 1, 3, and 4, according to some embodiments.

FIG. 6 is an exploded view of the vacuum interrupter and voltage harvester assembly of FIG. 5, according to some embodiments.

FIG. 7 is a schematic diagram showing an example of the distribution protection device connected to a power line of an electrical distribution system, according to some embodiments.

FIG. 8 is a front view of the voltage harvester assembly of FIG. 6, according to some embodiments.

FIG. 9 is a cross-sectional view of the voltage harvester assembly of FIG. 8 taken at section line 8-8, according to some embodiments.

FIG. 10 is a front view of the capacitive core of FIG. 9, according to some embodiments.

FIG. 11 is a cross-sectional view of the capacitive core of FIG. 9 taken at section line 10-10, according to some embodiments.

FIG. 12 is a schematic illustration showing details associated with some examples of the capacitive core of FIGS. 10 and 11, according to some embodiments.

FIG. 13 is a schematic illustration showing details associated with some examples of the capacitive core of FIGS. 10 and 11, according to some embodiments.

FIG. 14 is a schematic illustration showing details associated with some examples of the capacitive core of FIGS. 10 and 11, according to some embodiments.

FIG. 15 is an isometric view of an example of the capacitive core of FIGS. 10 and 11, according to some embodiments.

FIG. 16 is a cross-sectional view of the capacitive portion of the capacitive core of FIG. 15, taken at section line 15-15, according to some embodiments.

In the drawings, reference numbers may be reused to identify similar and/or identical elements.

### DETAILED DESCRIPTION

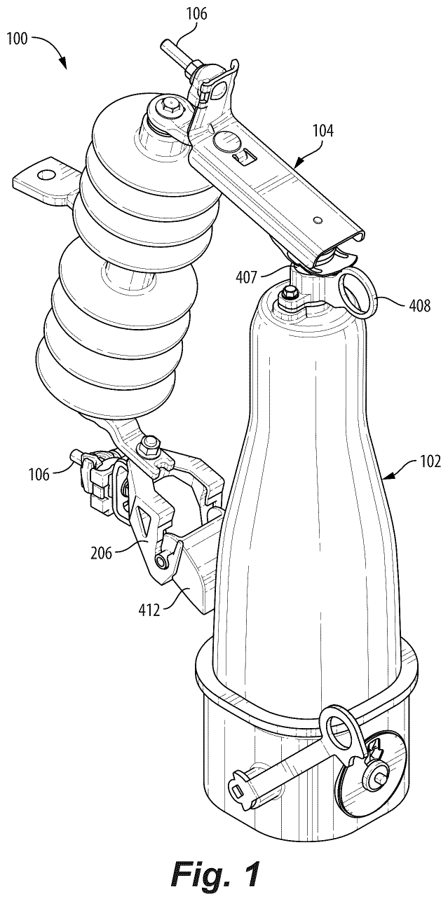

FIG. 1 is an isometric view of an example distribution protection device 100. In various implementations, the distribution protection device 100 may be implemented as a fuse, circuit breaker, recloser, and/or relay. For example, the distribution protection device 100 may be implemented as a self-powered recloser (such as a cutout-mounted single-phase self-powered recloser) and/or as a vacuum-bottle-based resettable fuse. In the example of FIG. 1, the distribution protection device 100 is implemented as a cutout-mounted recloser. As shown in FIG. 1, some implementations of the distribution protection device 100 includes a circuit interrupter 102 mounted to a distribution cutout 104. As will be described in this specification, the circuit interrupter 102 may selectively interrupt the flow of electricity through a power line 106.

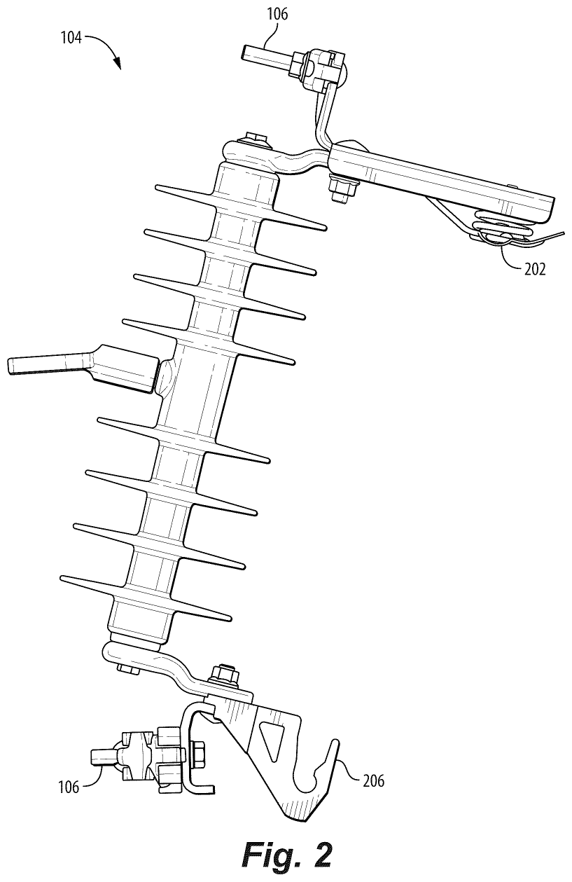

FIG. 2 is a front view of the distribution cutout 104 of FIG. 1. As illustrated in the example of FIG. 2, the distribution cutout 104 may include a terminal such as an upper contact 202 for electrically connecting the circuit interrupter 102 to the power line 106, a terminal such as a lower contact 206 for electrically connecting the circuit interrupter 102 to the power line 106. In various implementations, the lower contact 206 also functions as a mounting bracket for mechanically coupling the circuit interrupter 102 to the distribution cutout 104.

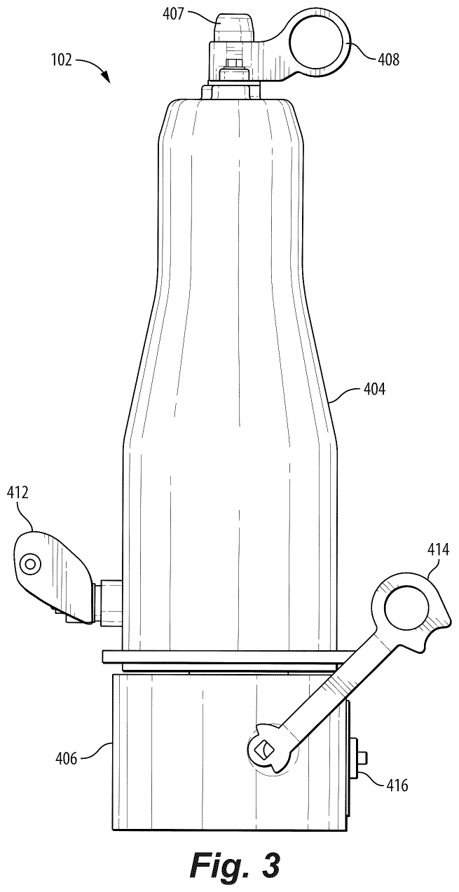

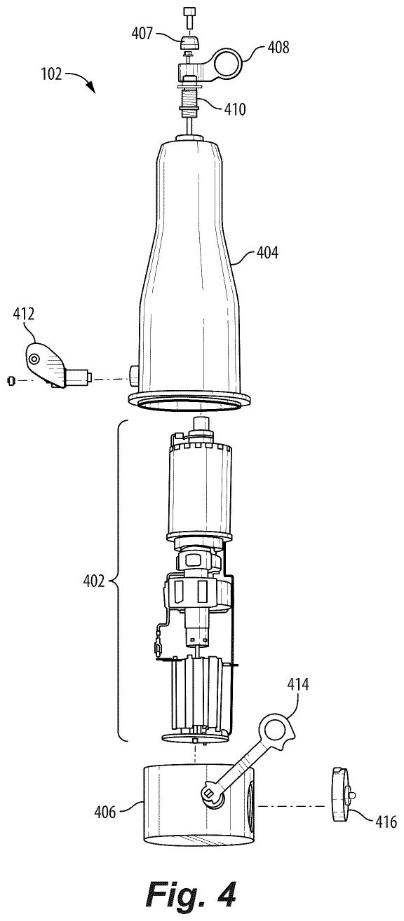

FIG. 3 is a front view of the circuit interrupter 102 of FIG. 1. FIG. 4 is an exploded view of the circuit interrupter 102 of FIGS. 1 and 3. As illustrated in the example of FIGS. 3 and 4, the circuit interrupter 102 may include an internal assembly 402 positioned within a top housing 404 and a bottom housing 406. The circuit interrupter 102 may also include a top cap 407 that secures a hook 408 and/or a contact connector 410 to the top housing 404. The top cap 407 may also protect the internal assembly 402 and/or other contents of the top housing 404 and the bottom housing 406 from the external environment. In various implementations, the top cap 407 mechanically couples the contact connector 410 to the upper contact 202 and the contact connector 410 electrically connects the internal assembly 402 to the power line 106 (for example, via the upper contact 202). In some examples, the hook 408 may be used to reposition the circuit interrupter 102 (for example, by closing the circuit interrupter 102 into the cutout 104) and/or to assist in opening the circuit interrupter 102 for maintenance or inspection (for example, a loadbreaker tool may be attached to the hook 408 to disconnect and break the circuit between the circuit interrupter 102 and the upper contact 202—for example, by breaking the connection between the upper contact 202 and the top cap 407).

A trunnion 412 may be mechanically coupled to the top housing 404 and mechanically couple the top housing 404 to the lower contact 206. In some examples, the trunnion 412 electrically connects the internal assembly 402 to the power line 106 (for example, via the lower contact 206). In various implementations examples, a manual operating handle 414 is mechanically coupled to the bottom housing 406 and allows an operator to manually open or close the circuitry of the internal assembly 402 (e.g., to manually open or close the circuit formed by the power line 106 and the circuit interrupter 102). In some examples, a time current characteristic (TCC) selector 416 provides a user interface that allows the operator to adjust operational settings of the circuit interrupter 102 (e.g., the timing and/or conditions under which the circuit interrupter 102 automatically recloses after detecting a fault).

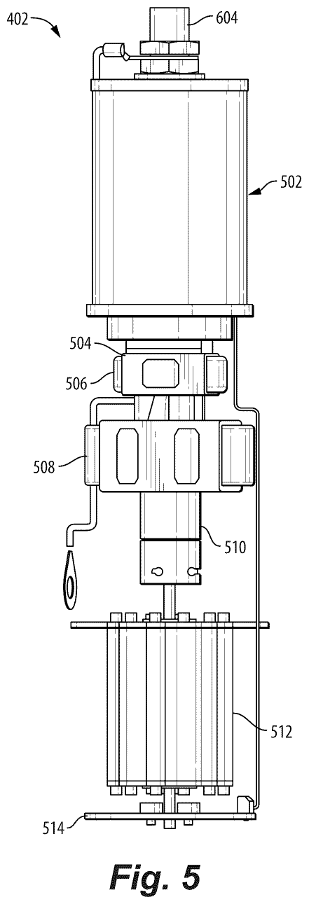

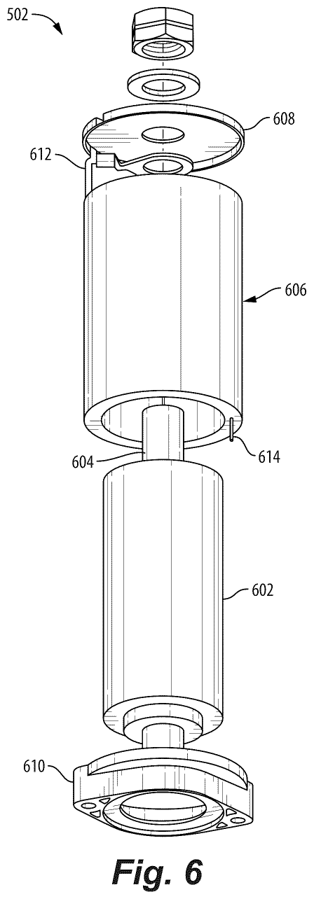

FIG. 5 is a front view of the internal assembly 402 of the circuit interrupter 102 of FIGS. 1, 3, and 4. As illustrated in the example of FIG. 5, the circuit interrupter 102 may include a vacuum interrupter and voltage harvester assembly 502, a current transformer holder 504, a sense current transformer 506, a current harvester 508, a drive assembly 510, a bistable magnetic actuator 512, and a control unit 514. FIG. 6 is an exploded view of the vacuum interrupter and voltage harvester assembly 502 of FIG. 5. As shown in the example of FIG. 6, the vacuum interrupter and voltage harvester assembly 502 may include a vacuum interrupter 602 connected in series with a power line 604. The vacuum interrupter 602 may have a substantially cylindrical shape, and a voltage harvester assembly 606 may be positioned around the vacuum interrupter 602. For example, the voltage harvester assembly 606 may have a substantially hollow cylinder shape and the vacuum interrupter 602 may be positioned within the inner radius (or inner diameter) of the voltage harvester assembly 606 (e.g., within the hollow central portion of the voltage harvester assembly 606).

The vacuum interrupter 602 and the voltage harvester assembly 606 may be mechanically secured between a top sleeve 608 and a bottom sleeve 610. In various implementations, the voltage harvester assembly 606 may be detached from the vacuum interrupter 602 when the top sleeve 608 and/or the bottom sleeve 610 are removed. Thus, in some examples, the voltage harvester assembly 606 may be referred to as a hollow-cylindrical detachable capacitive harvester.

In various implementations, the vacuum interrupter 602 includes two contacts (e.g., a fixed contact and a movable contact or two movable contacts within a vacuum-sealed envelope) that open or close the electrical circuit that the vacuum interrupter 602 completes.

In some examples, the trunnion 412, current harvester 508, vacuum interrupter 602, power line 604, and top cap 407 are electrically connected in series. Thus, when the circuit interrupter 102 is closed into the distribution cutout 104 (e.g., when the upper contact 202 is electrically connected to the top cap 407 and the lower contact 206 is electrically connected to the trunnion 412), the vacuum interrupter 602 may function as a switch that completes the electrical circuit formed by the power line 106, the upper contact 202, the power line 604, the lower contact 204, and the power line 106. Accordingly, when the contacts of the vacuum interrupter 602 are in the open position, the vacuum interrupter 602 opens the circuit and substantially interrupts the flow of electricity through the power line 604, which causes the circuit interrupter 102 to substantially interrupt the flow of electricity through the power line 106. Conversely, when the contacts of the vacuum interrupter 602 are in the closed position, the vacuum interrupter 602 completes the circuit and substantially allows the flow of electricity through the power line 604, which causes the circuit interrupter 102 to substantially allow the flow of electricity through the power line 106.

In various implementations, the voltage harvester assembly 606 may be electrically connected in series with the power line 604 via an input terminal 612 and electrically connected to various components to be powered via an output terminal 614. The voltage harvester assembly 606 may harvest electrical energy from the power line 604 and power various electronic components of the circuit interrupter 102, such as the vacuum interrupter 602.

Returning to FIG. 5, the current transformer holder 504 may hold or house the sense current transformers 506. The sense current transformers 506 may measure the current flowing through the power line 604, and the current transformer holder 504 may secure the sense current transformers 506 in optimal positions for accurate current measurement. The current harvester 508 may harvest electrical energy from the power line 604 and power various components of the circuit interrupter 102. The drive assembly 510 may be a mechanism that physically opens and closes the contacts within the vacuum interrupter 602. The bistable magnetic actuator 512 may be a drive mechanism for the drive assembly 510 that causes the drive assembly 510 to move the contacts of the vacuum interrupter 602 between the open and closed positions. In various implementations, the bistable magnetic actuator 512 may use permanent magnets to maintain the contacts of the vacuum interrupter 602 in the open or closed position (e.g., via the drive assembly 510) without the need for continuous power.

The control unit 514 may receive information from the sense current transformer 506 and/or other sensors of the circuit interrupter 102 and implement control logic to open or close the contacts of the vacuum interrupter 602. For example, the control unit 514 may control the bistable magnetic actuator 512 to open and close the contacts of the vacuum interrupter 602 by driving the drive assembly 510 according to the control logic. In various implementations, the control unit 514 receives time current characteristics curves and settings via the time characteristic curve selector 416 (e.g., input by the operator) and implements the control logic according to the time current characteristic curves. In some examples, the control unit 514 communicates with external systems for monitoring and control purposes.

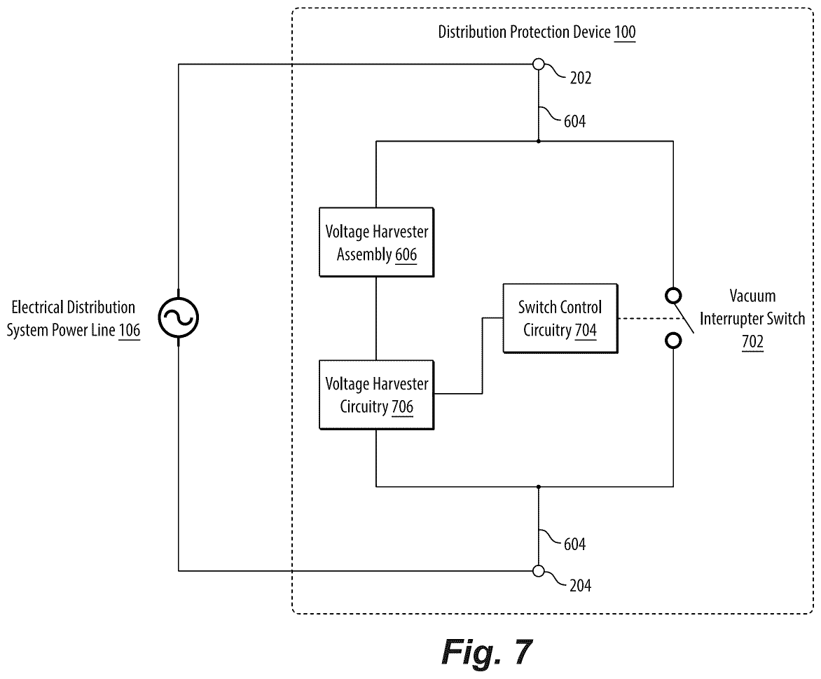

FIG. 7 is a schematic diagram showing an example of the distribution protection device 100 connected to the power line 106 of the electrical distribution system. As shown in FIG. 7, the distribution protection device 100 may be connected in series with the power line 106. Thus, the electrical path runs sequentially from the power line 106 into the distribution protection device 100 and back out into the power line 106. In such a configuration, the distribution protection device 100 effectively becomes part of the overall circuit of the power line 106, and electricity flowing through the power line 106 passes through the distribution protection device 100. Thus, substantially interrupting the flow of electricity through the distribution protection device 100 may also substantially interrupt the flow of through the power line 106.

As previously described, the vacuum interrupter 602 of the circuit interrupter 102 may include two contacts that function as a switch 702. The switch 702 may be electrically connected in series with the power line 106, the upper contact 202, the power line 604, and the lower contact 204. Thus, when the switch 702 is open, the vacuum interrupter 602 substantially interrupts the flow of electricity through the power line 106. Switch control circuitry 704 may control the opening and closing of the switch 702. In various implementations, the switch control circuitry 704 may include sensors, a microprocessor and/or an electronic controller, relays, a power supply, and/or a communications interface.

In some examples, the switch control circuitry 704 includes the sense current transformer 506 and/or the control unit 514. The sensors may detect electrical parameters such as voltage, current, temperature, and/or frequency at the power line 604. The microprocessor and/or electronic controller can interpret signals from the sensors and, based on programmed control logic, command the bistable magnetic actuator 512 to operate the switch 702. The power supply receives external power (for example, from the voltage harvester assembly 606) for powering the switch control circuitry 704. The communications interface may include interfaces for wired or wireless communications with central control systems of the electrical distribution system, allowing for remote configuration, monitoring, manual override, etc. from the central control systems.

The distribution protection device 100 may further include the voltage harvester assembly 606 and the voltage harvester circuitry 706 electrically connected in series between the upper contact 202 and the lower contact 204 and in parallel with the switch 702. In various implementations, the voltage harvester assembly 606 may be a capacitive energy harvester connected in series with the power line 604 (e.g., via the input terminal 612), which harvests and/or stores electrical energy from the power line 604. For example, in various implementations, the voltage harvester assembly 606 may include a plate capacitor, such as a multi-plate capacitor). Voltage of the AC power line 604 may change direction periodically. As the voltage of the power line 604 increases in one direction, the capacitor may charge by accumulating opposite electric charges on its plates. This charging process stores energy in the electric field between the plates. When the voltage of the power line 604 decreases (e.g., reverses direction), the capacitor may discharge, releasing stored electrical energy to the voltage harvester circuitry 706 and/or the switch control circuitry 704 (for example, to power the switch control circuitry 704). Thus, in various implementations, the voltage harvester assembly 606 harvests electrical energy from the power line 604 and provides electrical energy to the voltage harvester circuitry 706 (e.g., via the output terminal 614).

In various implementations, the voltage harvester circuitry 706 includes a rectifier circuit for converting the AC into a direct current (DC) (for example, high-voltage low-amperage DC), and/or a DC-DC converter to step down the voltage of the DC and/or stabilize the DC output from the voltage harvester circuitry 706. In some examples, the voltage harvester assembly 606 may include a high-impedance capacitor. In various implementations, the voltage harvester circuitry 706 includes various components for increasing impedance in the circuit formed by the voltage harvester assembly 606 and the voltage harvester circuitry 706. For example, the voltage harvester circuitry 706 includes one or more circuits including resistors, inductors, and/or capacitors for adding resistance, inductance, and/or capacitance to increase impedance in the high-impedance circuit. Thus, the circuit including the voltage harvester assembly 606 and/or the voltage harvester circuitry 706 may be a high-impedance circuit. Because the voltage harvester assembly 606 and/or the voltage harvester circuitry 706 form a high-impedance energy harvester circuit, the high-impedance circuit does not provide an alternative path for significant current flows between the upper contact 202 and the lower contact 204 when the switch 702 is open. However, the voltage harvester assembly 606 is still able to harvest electrical energy from the power line 604 even when the switch 702 is open.

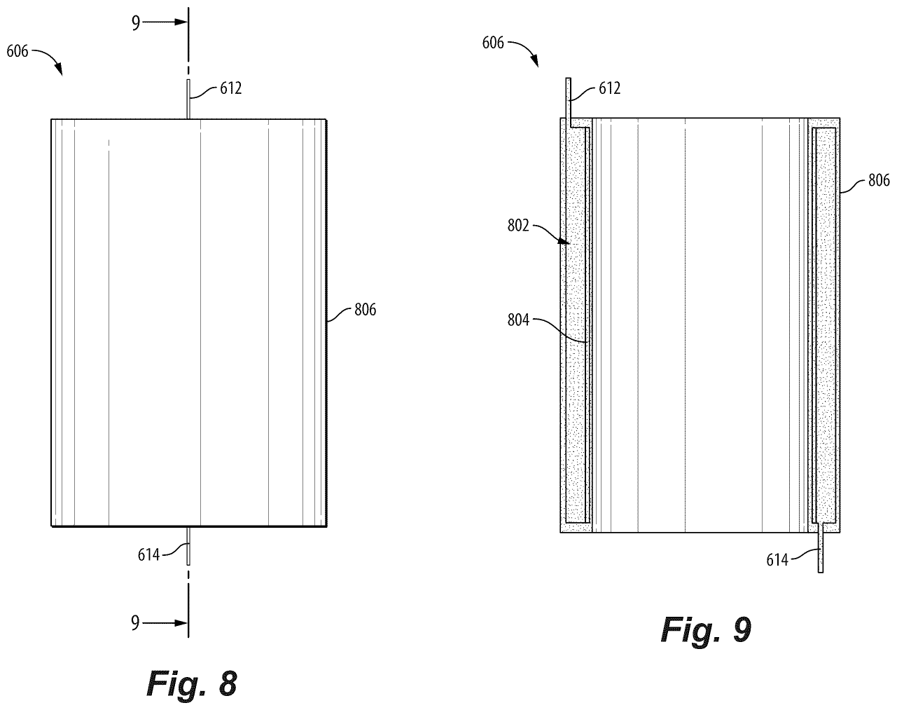

FIG. 8 is a front view of the voltage harvester assembly 606 of FIG. 6. FIG. 9 is a cross-sectional view of the voltage harvester assembly 606 of FIG. 8 taken at section line 8-8. As shown in the example of FIG. 9, the voltage harvester assembly 606 may include a capacitive core 802 formed as a substantially hollow cylindrical structure disposed around a support structure 804 also formed as a substantially hollow cylinder. In various implementations, the support structure 804 may be formed from a fiberglass material. The capacitive core 802 may be electrically connected to the power line 604 via the input terminal 612 and harvest electrical energy from the power line 604. In various implementations, the capacitive core 802 and/or the support structure 804 may be substantially encapsulated by an covering 806.

In some examples, the covering 806 may be formed from a dielectric material, such as silicone rubber or epoxy. In various implementations, the covering 806 may be formed as an overmold for the capacitive core capacitive core 802 and/or the support structure 804. Providing the covering 806 may improve the performance of the capacitive core 802. For example, the covering 806 may substantially cover the capacitive core 802, which may increase the overall capacity of the voltage harvester assembly 606 to withstand high voltages and reduce both the effects of electrical interference from external sources and any electrical interference that the voltage harvester assembly 606 may cause. The covering 806 may also provide thermal insulation for the capacitive core 802, keeping the capacitive core 802 at stable temperatures despite fluctuating environmental conditions. The covering 806 may also provide mechanical protection (for example, impact resistance and vibration dampening) for the capacitive core 802, reducing the risk of mechanical damage.

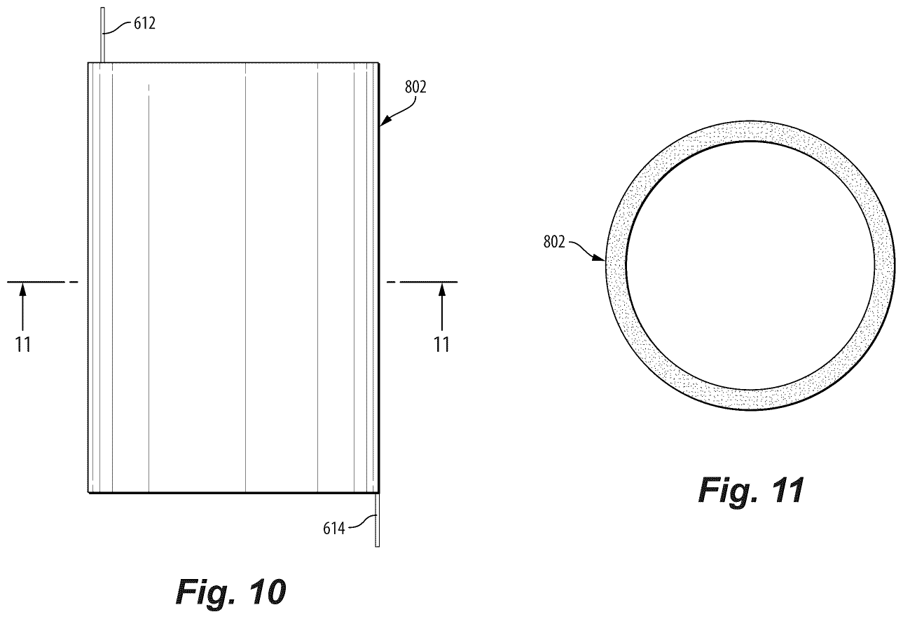

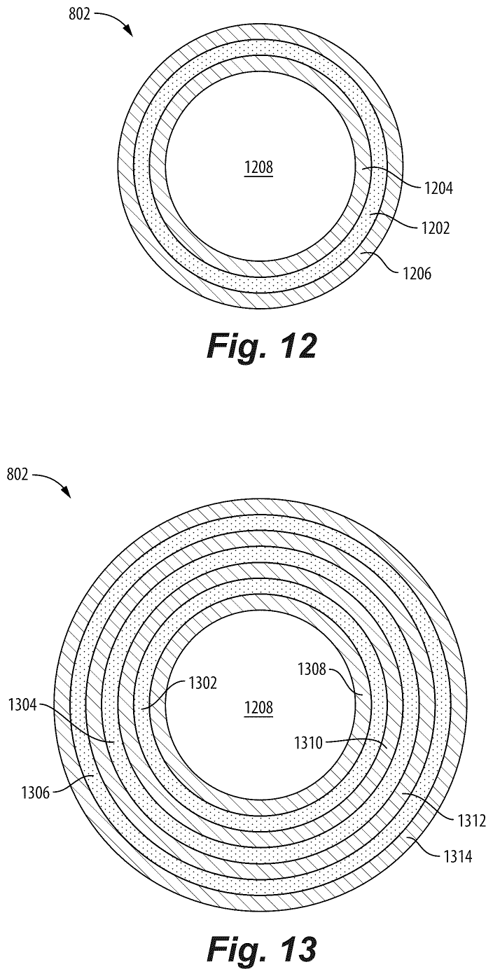

FIG. 10 is a front view of the capacitive core 802 of FIG. 9. FIG. 11 is a cross-sectional view of the capacitive core 802 of FIG. 9 taken at section line 10-10. FIG. 12 is a schematic illustration showing details associated with some examples of the capacitive core 802 of FIGS. 10 and 11. As shown in FIG. 12, the capacitive core 802 may include one or more dielectric layers, such as dielectric layer 1202, sandwiched between one or more capacitive layers, such as capacitive layer 1204 and capacitive layer 1206. In some examples, capacitive layers 1204 and 1206 and dielectric layer 1202 are arranged concentrically around a hollow central portion 1208 of the capacitive core 802. The capacitive layers may be connected in series with the AC power line 604 (e.g., via input terminal 612). In various implementations, the capacitive layers may be formed of a conductive material, such as a metal foil. For example, the metal foil can include an aluminum foil, a copper foil, a silver foil, a stainless steel foil, a gold foil, and/or a nickel foil. In some examples, the dielectric layers may be formed from dielectric materials, such as ceramic dielectrics, polymer dielectrics, composite dielectrics, glass, paper and cellulose-based dielectrics, etc. Examples of suitable ceramic dielectrics include barium titanate (BaTiO₃), titanium dioxide (TiO₂), and/or various ferroelectric ceramics. Examples of suitable polymer dielectrics include polymer films formed from polymers such as polyvinylidene fluoride (PVDF), polytetrafluoroethylene (PTFE), polyethylene terephthalate (PET), polypropylene, etc.

In various implementations, the dielectric layer 1202 may be a dielectric flexible circuit board In various implementations, the dielectric flexible circuit board is constructed of a polymer material, such as polyimide. The dielectric flexible circuit board may serve as a substrate for the capacitive layers 1204 and 1206. For example, the capacitive layers 1204 and 1206 may be metals deposited on a respective side of the dielectric layer 1202 using a plating technique (for example, an electroplating technique or an electroless plating technique).

As previously described, capacitive layers 1204 and 1206 may be electrically connected in series with the AC power line 604, which may be electrically connected to the upper contact 202 and the lower contact 204. The capacitive layers 1204 and 1206 may form a cylindrical plate capacitor, which may harvest or store energy from the power line 604 and provide the stored electrical energy to the voltage harvester circuitry 706 and/or the switch control circuitry 704 (for example, via the output terminal 614 as previously described).

FIG. 13 is a schematic illustration showing details associated with some examples of the capacitive core 802 of FIGS. 10 and 11. In various implementations, the capacitive core 802 includes multiple dielectric layers (such as dielectric layers 1302, 1304, 1306, etc.) sandwiched between pairs of capacitive layers (such as capacitive layers 1308, 1310, 1312, 1314, etc.). For example, the capacitive layers and the dielectric layers may be arranged in an alternating pattern extending concentrically outward from the hollow central portion 1208. Although three dielectric layers 1302-1306 and four capacitive layers 1308-1314 are shown in the example of FIG. 13, other implementations of the capacitive core 802 may include any number of dielectric layers sandwiched between any number of capacitive layers. In various implementations, the capacitive layers and the dielectric layers may be formed from any of the previously described materials.

In the example of FIG. 13, the capacitive layers may be connected in series with the power line 604 and form a cylindrical multi-plate capacitor. In various implementations, the cylindrical multi-plate capacitor may function as a voltage divider, outputting a lower voltage to the voltage harvester circuitry 706 and/or the switch control circuitry 704 than the line voltage of the power line 604. In various implementations, dividing the voltage has technical benefits of reducing the insulation requirement (for example, the thickness of the dielectric layers) between the capacitive layers and/or reducing the complexity of voltage limiting circuitry of the distribution protection device 100 (for example, voltage harvester circuitry 706).

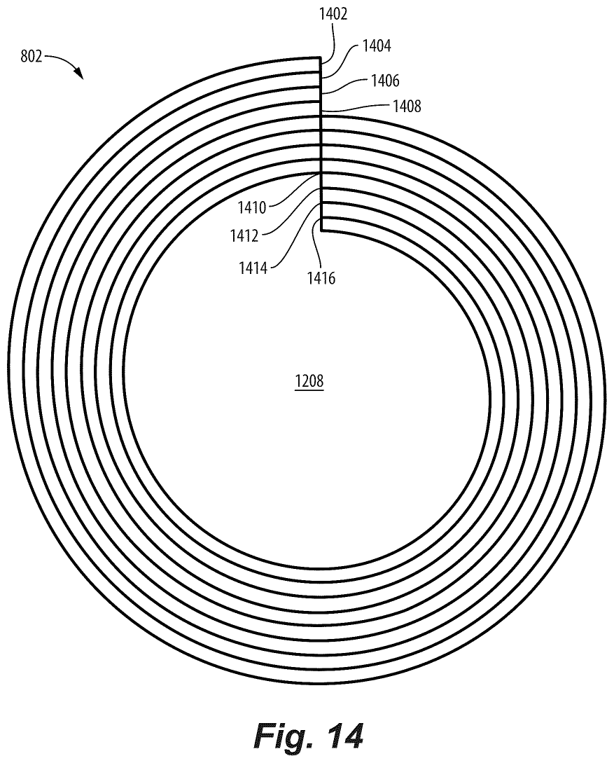

FIG. 14 is a schematic illustration showing details associated with some examples of the capacitive core 802 of FIGS. 10 and 11. In various implementations, the capacitive core 802 includes multiple dielectric layers (such as dielectric layers 1402, 1404, 1406, 1408, etc.) and multiple capacitive layers (such as capacitive layers 1410, 1412, 1414, 1416, etc.) disposed in an alternating arrangement to form a sandwiched structure. The combined structure (including the dielectric layers and the capacitive layers) may be wound in a spiral to form the capacitive core 802 (for example, defining a substantially cylindrical shape around the hollow central portion 1208). Although four dielectric layers 1402-1408 and four capacitive layers 1410-1416 are shown in the example of FIG. 14, other implementations of the capacitive core 802 may include any number of dielectric layers sandwiched between any number of capacitive layers. In various implementations, the capacitive layers and the dielectric layers may be formed from any of the previously described materials.

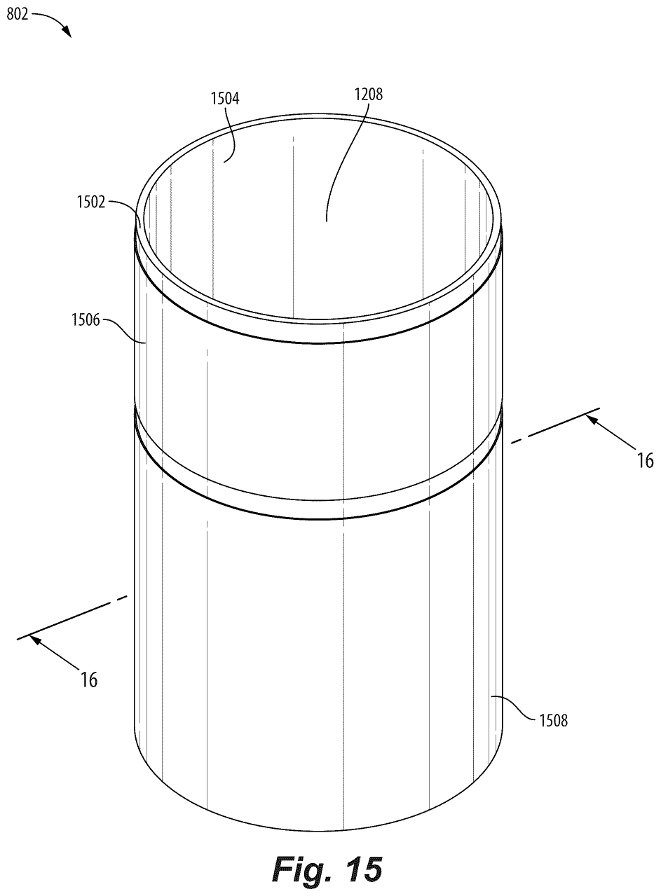

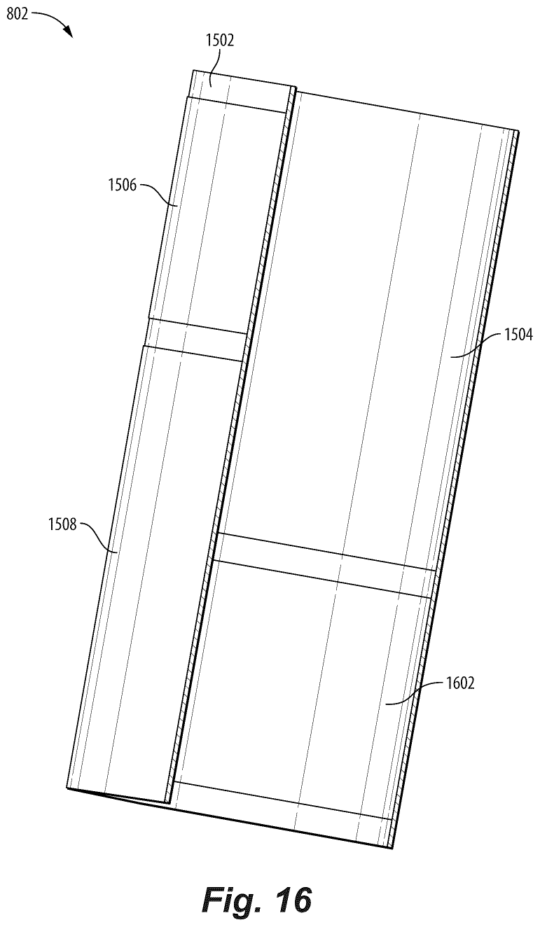

FIG. 15 is an isometric view of an example of the capacitive core 802 of FIGS. 10 and 11. FIG. 16 is a cross-sectional view of the capacitive portion of the capacitive core 802 of FIG. 15, taken at section line 15-15. In various implementations, the capacitive core 802 may include multiple overlapping capacitive sections on both sides of a dielectric layer 1502. Each capacitive portion and the dielectric layer 1502 may include any of the materials previously described with reference to the capacitive layers and dielectric layers, respectively. In some examples, the capacitive core 802 may include a capacitive portion 1504 and a capacitive portion 1602 positioned on an inner surface of the dielectric layer 1502 (for example, the surface facing towards the hollow central portion 1208). The capacitive core 802 may include a capacitive portion 1506 and a capacitive portion 1508 positioned on an outer surface of the dielectric layer 1502 (for example, the surface facing away from the hollow central portion 1208).

As shown in the example of FIGS. 15 and 16, each of the capacitive portions positioned on the outer surface of the dielectric layer 1502 overlaps with at least a portion of a capacitive portion positioned on the inner surface of the dielectric layer 1502. For example, as shown in the example of FIGS. 15 and 16, the capacitive portions 1506 and 1508 positioned on the outer surface of the dielectric layer 1502 overlap with different portions of the capacitive portion 1504 positioned on the inner surface of the dielectric layer 1502. The capacitive portion 1508 positioned on the outer surface of the dielectric layer 1502 also overlaps with the entirety of the capacitive portion 1602 positioned on the inner surface of the dielectric layer 1502.

The different overlapping portions of the capacitive portions create distinct capacitive interactions, effectively forming different capacitors. For example, the capacitive portion 1506 and the overlapping portion of the capacitive portion 1504 effectively form a first capacitor, while the portion of the capacitive portion 1508 overlapping with the capacitive portion 1504 and the portion of the capacitive portion 1508 overlapping with the capacitive portion 1602 effectively form a second capacitor and a third capacitor. Thus, the multiple overlapping capacitive portions effectively form multiple capacitors to divide the voltage harvested from the power line 604. Although two capacitive portions 1504 and 1602 are shown on the inner surface of the dielectric layer 1502 and two capacitive portions 1506 and 1508 are shown on the outer surface of the dielectric layer 1502, any number of capacitive portions may be positioned on the inner and outer surfaces of the dielectric layer 1502 and overlap in different ways to form any number of effective capacitors.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

The term computer-readable medium does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices-such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. A distribution protection device comprising:
a switch connected in series between a first terminal and a second terminal; and
an energy harvester connected in series between the first terminal and the second terminal and in parallel with the switch, the energy harvester including a first capacitive layer opposite a second capacitive layer, the first capacitive layer and the second capacitive layer forming a substantially cylindrical structure that substantially envelopes the switch;
switch circuitry configured to receive electrical power from the energy harvester and control operation of the switch.

2. The distribution protection device of claim 1, wherein the energy harvester forms a hollow cylindrical structure.

3. The distribution protection device of claim 1, wherein the energy harvester has an inner diameter and the switch is positioned within the inner diameter.

4. The distribution protection device of claim 1 wherein the energy harvester is detachable from the switch.

5. The distribution protection device of claim 1, wherein the energy harvester includes a dielectric layer positioned between the first capacitive layer and the second capacitive layer.

6. The distribution protection device of claim 1, wherein:
wherein the energy harvester is part of a high-impedance circuit between the first terminal and the second terminal; and
the high-impedance circuit includes energy harvester circuitry configured to receive alternating current from the energy harvester and provide direct current to the switch circuitry.

7. The distribution protection device of claim 6, wherein the energy harvester circuitry is configured to increase an impedance of the high-impedance circuit.

8. The distribution protection device of claim 1, wherein the energy harvester includes a dielectric layer covering the first capacitive layer and the second capacitive layer.

9. The distribution protection device of claim 1, wherein the energy harvester, the switch, and the switch circuitry are positioned within a housing.

10. The distribution protection device of claim 9, wherein the switch is a vacuum interrupter.

11. A distribution protection device comprising:
a power line extending between a first terminal and a second terminal;
a switch connected in series between a first terminal and a second terminal; and
a capacitive core extending around the switch, the capacitive core configured to harvest electrical power from the power line and connected in parallel with the switch; and
wherein the switch is configured to substantially interrupt a flow of electrical power between the first terminal and the second terminal in an open position; and
wherein the capacitive core is configured to continue harvesting electrical power from the power line when the switch is in the open position.

12. The distribution protection device of claim 11, wherein the capacitive core includes one or more dielectric layers sandwiched between one or more capacitive layers.

13. The distribution protection device of claim 11, wherein the capacitive core includes a plurality of dielectric layers sandwiched between a plurality of capacitive layers.

14. The distribution protection device of claim 13, wherein the plurality of capacitive layers forms a voltage divider.

15. The distribution protection device of claim 11, wherein the capacitive core includes a first plurality of capacitive sections disposed on a first side of a dielectric layer and a second plurality of capacitive sections disposed on a second side of the dielectric layer.

16. The distribution protection device of claim 15, wherein the first plurality of capacitive sections overlaps with the second plurality of capacitive sections.

17. The distribution protection device of claim 11, wherein the capacitive core is part of a first circuit and the switch is part of a second circuit, wherein the first circuit has a higher impedance than the second circuit.

18. The distribution protection device of claim 11, wherein the capacitive core and the switch are disposed within a housing.

19. The distribution protection device of claim 18, wherein the switch is a vacuum interrupter.

20. The distribution protection device of claim 18, wherein the first terminal and the second terminal are configured to be connected to an electrical distribution system power line.

21. A capacitive core for a distribution protection device comprising:
one or more dielectric layers sandwiched between one or more capacitive layers;
wherein the one or more dielectric layers and the one or more capacitive layers are configured to envelop a switch configured to substantially interrupt a flow of electrical energy through a power line a power line;
wherein the one or more dielectric layers and the one or more capacitive layers are configured to harvest electrical power from the power line;
wherein the capacitive core is configured to form part of a first circuit extending between a first terminal and a second terminal of the distribution protection device;
wherein the distribution protection device includes a second circuit configured to interrupt a flow of electrical power between the first terminal and the second terminal;
wherein the first circuit is in parallel with the second circuit;
wherein the first circuit has a higher impedance than the second circuit; and
wherein the one or more dielectric layers and the one or more capacitive layers are configured to continue harvesting electrical power from the power line when the second circuit interrupts the flow of electrical power between the first terminal and the second terminal.

22. The capacitive core of claim 21, wherein the one or more dielectric layers and the one or more capacitive layers are configured to provide the harvested electrical power to the second circuit when the second circuit interrupts the flow of electrical power between the first terminal and the second terminal.

23. The capacitive core of claim 21, wherein the first circuit is configured to receive alternating current from the one or more dielectric layers and the one or more capacitive layers and provide direct current to the second circuit.
